(19) United States
(12) Patent Application Publication
(10) Pub. No.: US 2002/0100378 A1
(43) Pub. Date: Aug. 1, 2002

(54) Objects having thereon printed full-color process image of high definition and methods for printing on the same

(76) Inventor: Richard Dupuis, Lac-du-Cerf (CA)

Correspondence Address: DARBY & DARBY P.C., 805 Third Avenue, New York, NY, 10022, US

(21) Appl. No.: 09/771,033

(22) Filed: Jan. 26, 2001

(51) Int. Cl. B41F 1/00

(52) U.S. Cl. 101/135

(57) ABSTRACT

The present invention relates to multicolor pad printing and, in particular to methods for printing a copy of a high quality multicolor image onto a substrate. The present invention is also concerned with objects having thereon a printed full-color process image of a high definition. The present invention provides a significant improvement upon known multicolor pad printing methods by combining known pad printing technologies with full-color printing process technologies. The method of the invention is very versatile and highly desirable since it allows for the first time to pad-print halftone multicolor images onto spherical, rounded, cylindrical and other unconventional shapes and surfaces.

### BACKGROUND OF THE INVENTION

a) Field of the Invention

The present invention relates to multicolor pad printing and, in particular to methods for pad printing a full-color process image onto the external surface of an object. The present invention is also concerned with objects having thereon a printed full-color process image of a high definition.

b) Brief Description of the Prior Art

There are a number of printing processes which are in common use, for printing in multicolor paper web sheets and preformed articles. In the most common color printing methods, an original multicolor image is photographed through halftone screens with color filters to reproduce each of the three subtractive primary colors, cyan, yellow and magenta, plus black. Conventional halftone screens have a regular grid pattern formed by intersecting opaque lines on a clear substrate, such as glass or plastic, leaving an array of clear dots. The screens break the photographic image into evenly spaced dots that are larger in size in the dark areas of the image and smaller in light areas. A 50 line screen, for example, contains 50 lines per inch in both dimensions and resolves an image into 2,500 dots per square inch (“dpi”). Similarly, a 300 line screen resolves to 90,000 dpi. Coarser screens, having 55 to 100 lines, are easier to make and use than finer screens, having between 133 to 300 lines. The greater the number of dots per inch, the greater the image sharpness and detail. There is a limit to how fine the screens can be made without printing problems.

The printing of paper web sheets and cardboard is usually effected by letterpress (relief printing), offset-lithography, gravure printing or rotogravure printing (such as U.S. Pat. No. 4,774,885). Although these methods have the capability of printing full-color images having a resolution of between 85 to 200 lines per inch, they are limited to the printing of paper web sheets and of cardboard no thicker than about 32 points (about 0.8 mm).

Serigraphy is a printing process which can be used for printing full-color images onto various types of objects, including objects made of wood, glass, plastic and of cardboard thicker than about 32 points (about 0.8 mm). However, the highest resolution achieved for a full-color image printed by serigraphy is 100 lines per inch only.

Thermal transfer is another printing process for printing full-color images. It involves the transfer of an image on an object by heat and contact pressure. Such process is commonly used for printing images onto note pad cubes or T-shirts. For instance, U.S. Pat. No. 5,817,210 describes a thermal transfer press. Thermal transfer is however limited in that it is necessary that the printed surface be planar to allow a sufficient contact pressure. Furthermore, the highest resolution achieved for a full-color image printed by thermal transfer is 133 lines per inch only.

Pad printing is highly desirable for printing spherical, rounded, cylindrical and other non-flat surfaces. Pad printing machines typically comprise a flexible ink transfer pad that receives an ink image from an inked gravure plate upon being placed into pressure contact therewith. The transfer pad is then removed from the gravure plate and placed into pressure contact with the surface to be printed. The flexible nature of the transfer pad enables the ink image to be transferred from the pad onto various printing surfaces. U.S. Pat. Nos. 5,694,839 and 5,806,419 describe pad printing systems and apparatuses.

Printing a multicolor image using known pad printing methods is however complicated and expensive. Indeed, costly individual gravure plates must be prepared for each one of the colors of the final image to be printed, and each one of these multiple colors has to be printed separately, the resolution of the final printed image being of about 100 lines per inch only. Furthermore, since pad printing is a “spot color” method, it is not possible to use the methods known in the art to print halftone images by pad printing. For various technical reasons, full-color image processing which consists in overlapping the three primary colors (namely yellow, red (magenta), blue (cyan)) and black to provide shading of color, has never been applied to pad printing.

There is therefore a long felt need for three-dimensional objects with a non-planar surface having thereon a printed full-color process image with a definition of over 100 lines per inch.

There is also a need for objects with a planar surface, other than objects made of fabric, paper, and cardboard with a thickness of less that 32 points (about 0.8 mm), having thereon such surface a printed full-color process image with a definition of over 100 lines per inch.

There is a need also for a method for pad printing a full-color process image onto the external surface of an object, and more particularly, for an improved multicolor pad printing method wherein full-color image processing is used for printing a plurality of overlapping primary colors, and thereby provide a shaded multicolor image.

The Applicant of the present invention has recently commercialized a product named SHUFFLE PUZZLE™. The SHUFFLE PUZZLE™ consists of a solid cubic puzzle having a printed multicolor image onto one of its sides. The puzzle is made of a plurality of cardboard sheets segments [from about 12 to 100 points thick (about 0.3 to 2.5 mm)], the segments showing the correct image when assembled in the proper order. The printed image is of very good quality with a resolution of 133 lines per inch.

The present invention fulfils the above-mentioned needs and also other needs which will be apparent to those skilled in the art upon reading the following specification.

### SUMMARY OF THE INVENTION

An object of the invention is to provide objects having thereon printed multicolor images, full-color process images, halftone images and the like.

It is also an object of this invention to provide spherical, rounded, cylindrical and other unconventional shaped objects with full-color process images having a high definition.

It is still a further object of this invention to provide an improved multicolor pad printing method wherein full-color image processing is used for printing a plurality of overlapping primary colors, and thereby provide a shaded multicolor image.

According to an aspect of the invention, there is provided an object with a surface having thereon a printed full-color process image, the image comprising a multitude of closely-spaced dots of at least three colors and having a definition of over 100 lines per inch, with the proviso that said object is made of a material other than fabric, paper or cardboard with a thickness of less than 32 points (about 0.8 mm).

According to another aspect of the invention, there is provided a three-dimensional object with a non-planar surface having thereon a printed full-color process image, the image comprising a multitude of closely-spaced dots of at least three colors and having a definition of over 100 lines per inch.

According to these two aspects of the invention, the image preferably comprises four colors consisting of yellow, red (magenta), blue (cyan) and black and has a definition of at least 133 lines per inch. More preferably, the image is a halftone image.

According to a further aspect of the invention, there is provided an improved method for pad printing a multicolor image onto an object, wherein the method comprises the step of processing the image using a full-color printing process. Preferably, a plurality of single colors, typically cyan, magenta, yellow and black, are overprinted in sequence and in registry onto the object by means of a pad printer apparatus, thereby giving a single multicolored continuous tone image. Typically, the printed multicolor image comprises a multitude of closely-spaced dots of at least three colors and has a definition of over 100 lines per inch.

According to another aspect of the invention, there is provided a method for printing a high quality multicolor image onto a substrate, comprising the steps of:

selecting a multicolor image to be printed;

producing a plurality of different single-color dot screens from the selected image;

providing a plurality of gravure plates each having an ink-receiving etched surface bearing one of said single-color dot screens;

mounting the plurality of gravure plates onto a pad printing machine;

applying wet ink to each of the gravure plates in the color of the screen from which the gravure plate is formed for forming thereon an ink image;

transferring while wet and by pressure contact, the ink image from each one of the gravure plates onto distinct flexible ink transfer pads;

transferring in sequence and in registry while wet and by pressure contact, the ink image from each one of said ink transfer pads onto the substrate, by starting from the lightest color to the darkest color; and

drying the transferred ink images.

According to a preferred embodiment, the gravure plates are prepared by forming a plurality of individual printing films each bearing the dots of a corresponding one-color dot screen; and using these printing films for forming a plurality of individual gravure plates each having an ink receiving etched surface wherein dots from a corresponding printing film are etched.

According to a preferred embodiment, the plurality of individual gravure plates are formed by:

a) providing a plurality of individual gravure plates each having a photosensitive surface;

b) positioning each of the printing films onto the photosensitive surface of an individual gravure plate, the films being registered one with the other onto the plates;

c) compressing each film on a corresponding gravure plate under a vacuum;

d) exposing the films and the plates to a light source for burning the image from the films onto the gravure plates;

e) developing the image burned on the gravure plates; and

f) drying the gravure plates.

More preferably, a suitable powder reducing stickiness of the gravure plates, such as a talcum powder, is applied onto the photosensitive surface of the gravure plates prior to positioning thereon the printing films, and this powder is removed during the development of the gravure plates.

An advantage of the above-mentioned methods is that it is very versatile and highly desirable, since it allows pad-printing of full-color process images such as halftone images onto objects and substrates having unconventional shapes and surfaces.

Other objects and advantages of the present invention will be apparent upon reading the following non-restrictive description of several preferred embodiments, made with reference to the accompanying drawings.

### BRIEF DESCRIPTION OF THE DRAWINGS

FIG. 1 is a flow diagram illustrating the steps of a preferred embodiment for reducing into practice the method of the invention.

FIG. 2 is a perspective view of an object with a planar surface having thereon a printed image according to the present invention.

FIG. 3 is a perspective view of a three-dimensional object with a non-planar surface having thereon a printed image according to the present invention.

Similar reference numerals are used in different figures to denote similar components.

### DESCRIPTION OF THE INVENTION

Pad printing, also called “imprinting”, is an indirect printing system wherein ink is laid down on an etched, very flat gravure plate, and then transferred to the object or piece to be printed. It is a relatively new printing system and it has evolved significantly over the last years. It has become widely accepted due to special features which allow easy printing on unconventional shapes and surfaces which are impossible to print with other printing techniques.

Pad printing machines typically comprise a flexible transfer pad that receives an ink image from the inked gravure plate upon being placed into pressure contact therewith. The transfer pad is then removed from the gravure plate and placed into pressure contact with the surface to be printed for transferring thereto the ink image. It is the flexible nature of the transfer pad that enables it to deform and conform to the surface and shape of the object to be printed.

The present invention brings pad printing to a higher level. Indeed, it provides a significant improvement upon known multicolor pad printing methods and greatly increases their application. In contradistinction to known pad printing methods wherein the resolution of the image printed is at the most of about 100 lines per inch, the resolution of the images printed according to the invention are of over 100 lines per inch, and regularly between 133 to 150 lines per inch. Although it has not yet been done with the method of the invention, it is conceivable to print images with a resolution of 200 lines per inch. Furthermore, the invention allows for the first time to imprint halftone images. Such an achievement was possible by combining known pad printing technologies with full-color printing process technologies, a combination that no one ever imagined nor thought feasible.

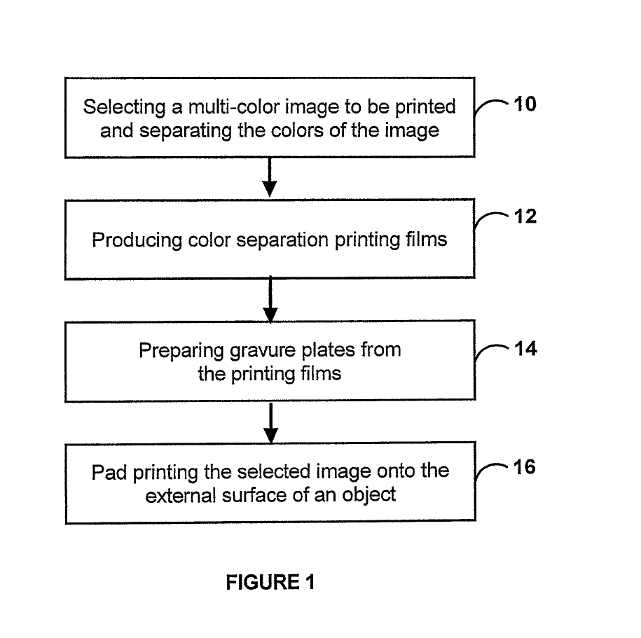

The foregoing and other objectives and advantages of the invention are realized by the new and improved methods (FIG. 1), which include preferably the following manipulative steps:

1. selecting a multicolor image to be printed and making a color separation of the image;

2. producing color separation printing films;

3. preparing gravure plates from the printing films; and

4. pad printing the selected image onto the external surface of an object with the gravure plates in sequence and in registry.

Step 1: Image Selection and Full-Color Image Print Processing

As it is well known in the art, single color continuous tone art may be reproduced in a single step by a single halftone printing plate. Multicolored continuous tone art involves several halftone printing plates overprinted on a substrate in sequence and in registry. The latter is called “full-color image print processing”. The full color spectrum can be approximated by overprinting three (preferably four) halftone plates, one for each of the traditional colors of yellow, magenta, cyan and, a fourth optional halftone plate for black. Because printing is subtractive, the overlapping of these colors reproduces the effect of the natural, additive, primary colors, red, green and blue. Considering each overprint to be a separate step, basic multicolored printing can be considered to be multi-step printing, involving three or four steps, depending on whether three or four halftone plates are used. Color separation of the image to be printed, also called “screening”, is an essential step in professional four-color process printing.

Initially, as indicated in block 10 of FIG. 1, an original multicolor image to be reproduced is selected. Because of the high definition appearance that the prints produced by the method of this invention have, it is preferable to select a high-quality image, although any multicolor original, including text, photographs, posters and the like may be used.

Subsequently, conventional color separation of the selected image is performed, a step which is also called “screening”. One of the most common techniques for “screening” an image to be printed is to use a scanner and a computer for making a separate continuous tone color separation for each of the colors of yellow, magenta, cyan and black. Generally, the scanner allows to electronically prescreen the image into four single-colored continuous tone screens. For better final results, it is generally preferable to use a high quality and high resolution scanner.

Then, a software such as ADOBE™ PHOTOSHOP™, ILLUSTRATOR™ or PAGE MAKER™ is used for producing at least three screens. Preferably, four screens are produced and some recently developed techniques even allow the production of six individual screens The screens comprise a multitude of closely-spaced dots of a single color corresponding substantially in appearance to the selected image according to the colors present in the image selected. Very fine dot patterns and dot sizes can be accommodated by the printing method of the invention, resulting in exceptional image detail. Preferably, the screen includes over about 10,000 dots per square inch (dpi), viz. over about 100 lines per inch in both dimensions, and more preferably, at least about 17,689 dpi (over about 133 lines per inch), and even more preferably, between about 17,689 to 22,500 dpi (about 133 to 150 lines per inch).

In color separation processing, the dot has a specific size, and depending on its size, more or less ink will be printed, thereby giving a printed image with a high or a low saturation, respectively. Since the printing method of the invention uses a pad printer, an apparatus which is known to create a “dot gain”, it is preferable, according to the present invention, to eliminate very high and very low contrast when screening the image. More preferably, the screens have a dot saturation that is adjusted between about 5% to 85% to obtain a final printed image with higher contrast.

It is also well known in the art that alignment of the screens is important to obtain a perfect image. If the screens (and later on the printing films and the gravure plates) are not adjusted and registered correctly, Moiré patterns will appear. Typically, each of the dot screens has an angular orientation with respect to each other: 90° for yellow, 75° for red (magenta), 105° for blue (cyan) and 45° for black.

Step 2: Producing Color Separation Printing Films

Once the screens have been prepared and adjusted, a plurality of transparent printing films, each bearing the dots of a one-color dot screen, are prepared in a conventional manner indicated in block 12 of FIG. 1.

Transparent printing films generally have an emulsion side and a support side. As it will be described in detail hereinafter, the gravure plate also has an emulsion side. According to a preferred embodiment, the films are prepared with their emulsion side down, thereby giving a “positive” image of the original image. By using a positive image, the present invention permits noticeably a greater resolution and clarity than processes using negatives. However, as it is well known in the art, negative images can also be used if the image is screened at step 1 into a negative form. Later on, the positive image of the film will be put in direct contact with the emulsion side of a gravure plate for forming a “negative” image on the gravure plate, and then subsequently, a “positive” image on the object to be printed.

Subsequently, the films are developed using a standard printing film developer such as those sold by KODAK™.

Step 3: Gravure Plate Making

Each of the halftone printing films is converted to a halftone gravure printing plate using a suitable metallic substrate and photo-polymeric techniques that are well known in the art, as indicated in block 14 of FIG. 1. Any suitable gravure plate may be used. Typically, the gravure plate comprises a photosensitive emulsion side laminated to and supported by a thin flexible steel plate.

According to a preferred embodiment of the invention, the printing films are used for preparing a plurality of individual gravure plates each having an ink receiving etched surface wherein dots from a corresponding printing film are etched. The gravure plates sold on the market are generally made of extremely hard steel or plastic (photo-polymer) with an etch depth of 15-30 microns, shallower ones being used for lines, texts and fine lines and deeper ones being used for solid prints or thick lines. One must take into account that the deeper the etches are, the more critical transfer conditions will be. The use of a plate with and etched halftone or screened pattern (200-300 lines) reduces ink thickness non-homogeneity, prevents air from getting trapped and favors a better cleaning of the plate by the doctor blade (see step 4). Preferred gravure plates include those sold by PENTEX™ under the name PTX-49™. However, rigid engraved printing plates are also suitable according to the invention.

According to a preferred embodiment of the invention, the dots on the printing films are engraved on the gravure plates by “burning” or “imaging” the plates. To do so, the positive image of each film is put in direct contact with the emulsion side of a gravure plate. As mentioned previously, it is very important that all the films be registered on each of the gravure plates to avoid the apparition of the so-called Moiré patterns at printing. According to a preferred embodiment of the invention, special register pins are used for positioning each film with each plate. Then, the plates and the films are exposed to a light source, thereby “burning” the gravure plates. More preferably, the films and the plates are compressed together using a pneumatic chassis to ensure no off-contact during the burning. Once burned, the plates are developed according to the manufacturer's instructions, typically by plunging them in a alcohol base product, washing with water and drying in an oven.

Interestingly, it has been found that it is advantageous to reduce stickiness of the gravure plates and to avoid adhesion of the film to the plate. Such procedure allows to obtain a printed image of a much better quality. According to a preferred embodiment of the invention, a thin layer of a suitable powder, such a talcum powder, is applied uniformly onto the plate prior to positioning thereon the printing film. The powder is later removed during the developing/washing steps.

Although not described in detail herein, it is also a well known procedure to use a photomechanical process, also known as “Ready In Process” (RIP), for producing a series of halftone gravure plates. These methods skip the preparation of printing films and the single-color screens are burned directly onto the gravure plates. Although it has not been tested, it is believed that the RIP technology could be adapted without undue experimentation for pad printing an image according to the invention. Therefore, the present invention encompasses the use of the RIP for pad-printing full-color process images.

The Applicant has however tested gravure plates made of steel and good printing results were obtained using these plates. Therefore, the present invention encompasses the use of such highly durable plates and of any other similar suitable plates.

Similarly, methods for producing a series of halftone gravure plates using a “random screen” have been developed in color printing. Such methods are described in U.S. Pat. Nos. 4,037,533; 5,283,154 and 5,429,047, which are incorporated herein by reference. Through computer techniques, the distribution of very small dots is carefully randomized and the dots are positioned to reproduce the image, but in an undeterminable pattern. In light-colored areas, single-spaced dots will appear, while in heavily-colored areas, the dots form in randomly-shaped clumps. This method is generally called “stochastic” or “FM” screening. This substantially eliminates Moiré patterns and “rosette” color clumps while simplifying printing with more than four colors. Although it has not been tested either, it is believed that stochastic screening methods could also be adapted without undue experimentation for pad printing an image according to the present invention. Therefore, the present invention also encompasses the use of these known methods for pad-printing full-color process images.

Step 4: Pad Printing

As shown in block 16 of FIG. 1, the last step generally consists in the pad printing step. Pad printing systems and apparatuses are well known in the art and are described in a plurality of patents such as U.S. Pat. Nos. 5,694,839 and 5,806,419 which are incorporated herein by reference. Pad printing methods typically comprise five steps: 1) a gravure plate with an etched image is inserted into the printer; 2) the gravure plate is inked over completely and wiped by a doctor blade in order to obtain a clean plate with only the etched image inked; 3) a flexible ink transfer pad presses down and picks up the ink image from the plate; 4) the pad moves into print position and simultaneously, the gravure plate is being inked for the next application; and 5) the transfer pad descends and presses down onto the object to be printed, thereby transferring thereto the ink image.

It is known in the art to pad-print multicolor images by “spot-color”, a technology which does not permit to print halftone images. According to the spot-color technology, individual gravure plates are prepared for almost each one of the colors of the final image to be printed. The plates have an etched surface corresponding to the “spot” of the color to be printed. The plates are then fully inked with one of the various colors and each one of the inked colored images are transferred separately, in sequence and in registry to the object to be printed. The various colors are overlapped for creating an intermediary color (for instance blue+yellow=green). Therefore, to print an image with ten different colors, from 6 to ten different gravure plates must be prepared.

As explained previously, the present invention brings pad printing to a higher level since it combines known pad printing methods with full-color printing process technologies. The result is a printed halftone color image of a very high resolution and of very high quality.

Many known pad printing apparatuses are suitable to reduce into practice the methods of the invention and a person skilled in the art will be able to chose an apparatus according to its printing needs. Preferably, the pad printing apparatus will be a multicolor pad printer adapted for printing at least three, and more preferably four colors. Even more preferably, the pad printer will comprise a closed cup system and a conveyor with a plurality of printing stations. A suitable example of a four color pad printer with all these characteristics is the PTX-4000SC™ from PENTEX™ (Toronto, ON, CA). The invention is however not limited to multicolor pad printers, since it is conceivable, although more laborious, to print a multicolor image using a plurality of single color pad printers.

Although the pad printer comprises a pad which is preferably made of silicone rubber, the composition, size, geometry and hardness of the pad may vary according to the object to be printed and to the dimension of the print area. It is known in the pad printing industry that the selection of the pad is very important, since during ink pick-up and then, during transfer, the pad shows a proper rolling, speed, and least possible deformation while eliminating any entrapped air. Most favorable transfers are normally obtained from the harder pads.

According to a preferred embodiment of the invention, the gravure plates prepared as described previously are inserted into a multicolor pad printer. As explained previously, it is important that the plates be registered to ensure printing of an image of a high quality. Then, each of the gravure plates is inked with the appropriate single color ink (cyan, magenta, yellow and black), the plates are cleaned with a doctor blade (preferably of hardened steel in the 0.006 to 0.2 inch (0.15 to 5 mm thickness range), such that each plate comprises a single color ink image. Subsequently, the ink images from the plates are transferred by the pad and overprinted in sequence and in registry onto a desired object, such that the combination of the halftone processed colors and black reproduces a single multicolored continuous tone image with a more or less high degree of tonal fidelity to the original copy over the full color spectrum.

Although it is highly preferable to use four plates for printing the four colors of cyan, magenta, yellow and black to print high quality halftone images, the present invention is not limited to the printing of these four colors. For instance, depending on a particular use, black could be omitted since its major function is to enhance the contrast of the final image. It is also conceivable to use the present invention for printing halftone images, duochrome and trichrome images, enhanced monochrome halftone images (duotone and tritone), enhanced duochrome halftone images (tritone), and enhanced four color separation images. A definition for these terms is found in U.S. Pat. No. 5,283,154 which is incorporated herein by reference. A person skilled in the are of printing will know how to adapt the method of the invention to print such images.

During the printing process, the following details should be observed to ensure that the printed image be of the best possible quality. First, whenever practical, the pad should be adjusted over the gravure plate so that the pad extremity lands first on a non-etched area of the gravure plate. This will reduce entrapping of air or splashing of ink. Secondly, pad deformation, both during pickup and during transfer, should be slightly bigger than the print area perimeter. Thirdly, residual ink on the pad after the transfer (ghosting) should be kept minimal since too much residual ink will hamper future ink pick-up. Fourthly, it may be preferable to dry each one of the color ink images transferred onto the external surface of the object to be printed prior to transferring another color ink image.

It is also known in the art that inks can make a dramatic difference to the resulting quality of the printed image as to the productivity of the method. According to the present invention, the inks may comprise additives such as hardeners, anti-wear bases, anti-blocking bases, retarding pastes, leveling additives, thinners, etc. for printing onto different types of surfaces. The inks used according to the invention should meet certain basic requirements in order to obtain satisfactory performance. Preferably, the ink will have a high opacity (covering power) and a good color intensity in order to get a proper contrast from the thin layer that is deposited onto the object. Also, a proper balance should be maintained in solvent evaporation from the ink and diluents to ensure a sufficient adhesive power of the ink layer deposited, and mechanical and chemical strength properties of the inks should be controlled. A person skilled in the art will know how to adjust these variables in order to fit his specific needs.

The method of the invention may also comprise other steps such as pre-treating the object to be printed for increasing ink adhesion, substantially drying the transferred ink before another ink is applied to the object, applying additional color(s) to the printed image, coating the final printed image with a transparent to translucent material for increasing the durability of the image or it glossiness, etc.

As can be appreciated, the method of the invention is very versatile and highly desirable for printing multicolor images onto spherical, rounded, cylindrical and other unconventional shapes and surfaces. It can be adapted for printing of a lot of items in unitary or massive production and for specific applications. According to the invention, about any planar and three-dimensional objects can be printed on. The object can be made of paper, cardboard (any thickness), wood, glass, wax, plastic, metal, ceramic, rubber, etc. The object surface onto which the image is to be printed may be convex, concave, dimple, irregular, grooved, granular, smooth, rough, and/or ribbed. Balls, cans, bottles, tools, hardware, toys, lids, cassette tapes, compact disks, office equipment, toiletries, travel goods, utensils, sport equipment, promotional goods, car parts, eggs, etc., are some non-limiting examples of objets that can be printed on according to the invention.

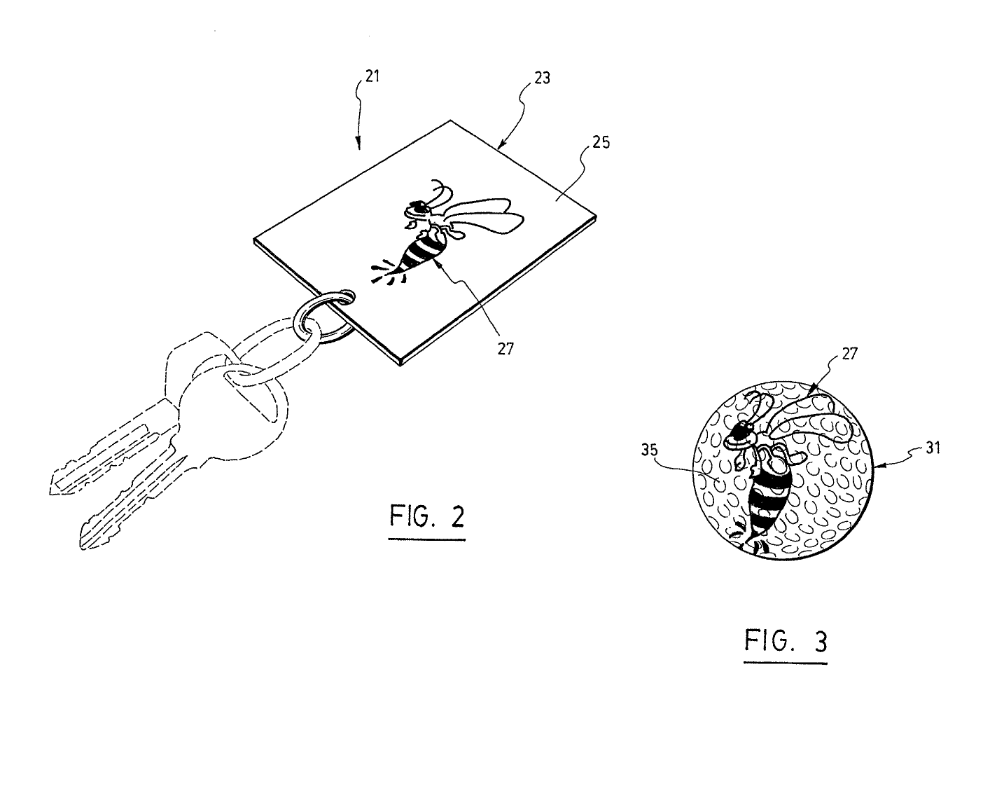

For instance, FIG. 2 shows a key ring 21 comprising a plate 23 with a planar smooth surface 25 onto which is printed a multicolor image of a bee 27 (colors not shown) according to the method of the invention. FIG. 3 shows a golf ball 31 which comprises a three-dimensional dimple surface 35 onto which is printed a multicolor image of a bee 27 (colors not shown) according to the method of the invention.

In contradistinction to images printed according to known pad printing methods, the resolution of the images printed according to the invention is of over about 100 lines per inch in both dimensions (over about 10,000 dots per square inch (dpi)). Typically, the resolution of the printed images is adjusted to about 133 lines per inch (17,689 dpi) and it is conceivable with the present invention to obtain images of 150, 175 and even 200 lines per inch (22,500, 30,625 and 40,000 dpi) and even of higher resolution, depending on the screening process, the pad printer, the inks and other variables.

### DESCRIPTION OF PREFERRED EMBODIMENTS

The specific characteristics of the invention will become more apparent when the description of the invention is read in view of the following examples. Theses examples are illustrative of the wide range of applicability of the present invention and are not intended to limit its scope. Modifications and variations can be made therein without departing from the spirit and scope of the invention.

### EXAMPLE 1

### Printing a Multicolor Picture Onto a Golf Ball

A color picture of a famous golfer was downloaded from the internet and four positive screens for each of the colors of yellow, red (magenta), blue (cyan) and black, were produced. Each screen comprised a multitude of closely-spaced dots of a single color. The screens were adjusted to includes 17,689 dots per square inch (dpi), viz. 133 lines per inch, and to have a dot saturation of 5% to 85%. The angular orientation of the screens was also adjusted with the software: 90° for yellow, 75° for red (magenta), 105° for blue (cyan) and 45° for black.

Four printing films were prepared from the four screens. Positive films having an emulsion side and a support side sold by FUGI™ under the name RED LAZER FILM™ (HIR-N 0.004 thickness) were used. The films were prepared and developed using standard developing methods, the films having their emulsion side down for giving a “positive” image of the screened image.

Each of the halftone printing films was converted to a halftone gravure printing plate using an improved conventional technique. Briefly, PENTEX™ PTX-49™ films comprising a photosensitive emulsion side laminated to and supported by a thin flexible steel plate were used. A thin layer of talcum powder was applied uniformly onto the emulsion side of the plates to reduce their stickiness. The image of the printing films prepared as described previously was put in direct contact with the emulsion side of the gravure plates. Since it is very important that all the films be registered one. with the other on each of the gravure plates, special register pins were fixed to opposite diagonal extremities of the plates for facilitating the positioning of each film onto the plates.

The gravure plates were burned by exposing the plates and the films exposed to a fluorescent light source (50 watts black light fluorescent tubes) for 48 sec. A pneumatic chassis ensured no off-contact of the plates and the films during the burning.

Once burned, the plates were developed according to the manufacturer's instructions. Briefly, the printing films were removed and the plates were plunged into a mixture of 90% PTX-49™ plate developer/10% water for 30 sec. while rubbing the emulsion side of the plate. The plates were then washed in pure cold water for 1 min. An air compressor was used for eliminating excess of water and finally the plates were baked in an oven for about 4 hours at about 72° F. (about 22° C.).

The plates were positioned into a PTX-4000SC™ four-color pad printer (PENTEX™, Toronto, ON, CA). The plates were positioned from the lightest color to the darkest color (yellow, magenta, cyan and black) according to the rotation of the pad printer. The plates were adjusted in order to assure their registry one with the other.

Inks for each of the four colors to be printed were prepared and poured into closed cups of the printer. The following inks from INK-FLEX™ (Toronto, ON, CA) were used: MP-2000 HFAM™ (yellow halftone), MP-2000 HFR™ (red halftone), MP-2000 HFAZ™ (cyan halftone) and MP-2000 HFN™ (black halftone). Ink viscosity was adjusted by adding therein about 30% of MP-2000-101™ additive (INK-FLEX™). Since golf balls were to be printed, 15 to 20% of a hardener MP-2000-51™ (INK-FLEX™) was added to each ink.

Golf balls were installed into the conveyor pad printer printing stations and a fully automatic printing run was started. The plates were inked with one of the various colors and each one of the inked colored images was transferred separately, in sequence and in registry onto the golf balls. The overlapping of the four colors produced a halftone color image of a very high resolution and of very high quality equal to the quality of the original picture. The image had a lot of details and very nice halftone colors (not shown). The definition of the printed image was of about 133 lines per inch. A layer of epoxy, a hardener, was then spread over the image and it was left to dry for 24 hours.

While several embodiments of the invention have been described, it will be understood that the present invention is capable of further modifications, and this application is intended to cover any variations, uses, or adaptations of the invention, following in general the principles of the invention and including such departures from the present disclosure as to come within knowledge or customary practice in the art to which the invention pertains, and as may be applied to the essential features hereinbefore set forth and falling within the scope of the invention or the limits of the appended claims.

What is claimed is:

1. An object with a surface having thereon a printed full-color process image, said image comprising a multitude of closely-spaced dots of at least three colors and having a definition of over 100 lines per inch, with the proviso that said object is made of a material other than fabric, paper or cardboard with a thickness of less than about 32 points (about 0.8 mm).

2. The object of claim 1, wherein the image has four colors consisting of yellow, red (magenta), blue (cyan) and black.

3. The object of claim 1, wherein the image has a definition of at least 133 lines per inch.

4. The object of claim 1, wherein the image is a halftone image.

5. The object of claim 1, wherein said object is selected from the group consisting of cans, bottles, balls, tools, hardware, toys, lids, cassette tapes, compact disks, office equipment, toiletries, travel goods, utensils, sport equipment, promotional goods, car parts and eggs.

6. The object of claim 1, wherein said object is made of a material selected from the group consisting of cardboard with a thickness of over about 32 points (about 0.8 mm), wood, glass, wax, plastic, metal, ceramic and rubber.

7. The object of claim 1, wherein the object surface onto which said image is printed is selected from surfaces which are convex, concave, dimple, irregular, grooved, granular, smooth, rough, and ribbed.

8. A three-dimensional object with a non-planar surface having thereon a printed full-color process image, said image comprising a multitude of closely-spaced dots of at least three colors and having a definition of over 100 lines per inch.

9. The object of claim 8, wherein the image has four colors consisting of yellow, red (magenta), blue (cyan) and black.

10. The object of claim 8, wherein the image has a definition of at least 133 lines per inch.

11. The object of claim 8, wherein the image is a halftone image.

12. The object of claim 8, wherein said object is selected from the group consisting of cans, bottles, balls, tools, hardware, toys, lids, cassette tapes, compact disks, office equipment, toiletries, travel goods, utensils, sport equipment, promotional goods, car parts and eggs.

13. The object of claim 8, wherein said object is made of a material selected from the group consisting of cardboard with a thickness of over about 32 points (about 0.8 mm), wood, glass, wax, plastic, metal, ceramic and rubber.

14. The object of claim 8, wherein the object surface onto which said image is printed is selected from surfaces which are convex, concave, dimple, irregular, grooved, granular, smooth, rough, and ribbed.

15. In a method for pad printing a multicolor image onto an object, the improvement wherein said method comprises the step of processing said image using a full-color printing process.

16. The method of claim 15, with the proviso that said object is not a shuffle puzzle.

17. The method of claim 16, wherein a pad printer apparatus is used overprinting in sequence and in registry a plurality of single colors onto the object, thereby giving a single multicolored continuous tone image.

18. The method of claim 16, wherein said colors consist of cyan, magenta, yellow and black, thereby giving a halftone high quality printed image.

19. The method of claim 15, wherein said object is three-dimensional and wherein said image is printed onto a non-planar surface of the object.

20. The method of claim 16, wherein the printed multicolor image comprises a multitude of closely-spaced dots of at least three colors and has a definition of over 100 lines per inch.

21. The method of claim 16, wherein the image has four colors consisting of yellow, red (magenta), blue (cyan) and black, and wherein the printed image has a definition of at least 133 lines per inch.

22. The method of claim 16, wherein the object surface onto which said image is printed is selected from surfaces which are convex, concave, dimple, irregular, grooved, granular, smooth, rough, and ribbed.

23. A method for printing a high quality multicolor image onto a substrate, comprising the steps of:
selecting a multicolor image to be printed;
producing a plurality of different single-color dot screens from the selected image;
providing a plurality of gravure plates each having an ink receiving etched surface bearing one of said single-color dot screens;
mounting said plurality of gravure plates onto a pad printing machine;
applying wet ink to each of said gravure plates in the color of the screen from which the gravure plate is formed for forming thereon an ink image;
transferring while wet and by pressure contact, the ink image from each one of said gravure plates onto distinct flexible ink transfer pads;
transferring in sequence and in registry while wet and by pressure contact, the ink image from each one of said ink transfer pads onto the substrate, by starting from the lightest color to the darkest color; and
drying the transferred ink images.

24. The method of claim 23, wherein the full-color image is separated into at least four individual one-color dot screens, said four colors consisting of yellow, red (magenta), blue (cyan) and black.

25. The method of claim 23, wherein each of the dot screens has an angular orientation with respect to each other.

26. The method of claim 23, wherein the individual one-color dot screens have a dot saturation that is adjusted between about 5% to 85%.

27. The method of claim 23, wherein the full-color image is separated into at least four individual one-color dot screens, said four colors consisting of yellow, red (magenta), blue (cyan) and black, and wherein the angular orientation is 90° for yellow, 75° for red (magenta), 105° for blue (cyan) and 45° for black.

28. The method of claim 23, wherein the ink image from each one of said ink transfer pads is transferred onto the external surface of the object to be printed in the sequential order yellow, red (magenta), blue (cyan) and black.

29. The method of claim 23, wherein each one of the color ink images transferred onto the external surface of the object to be printed is allowed to dry prior to transferring another one of said color ink images.

30. The method of claim 23, wherein said transfer pads are made of silicone.

31. The method of claim 23, wherein the wet inks applied onto the gravure plates have a viscosity that is adjusted with an additive.

32. The method of claim 23, wherein the gravure plates are prepared by:
a) forming a plurality of individual printing films each bearing the dots of a corresponding one-color dot screen; and
b) using said plurality of printing films for forming a plurality of individual gravure plates each having an ink receiving etched surface wherein dots from a corresponding printing film are etched.

33. The method of claim 32, wherein the plurality of individual gravure plates are formed by:
a) providing a plurality of individual gravure plates each having a photosensitive surface;
b) positioning each of said printing films onto the photosensitive surface of an individual gravure plate, the films being registered one with the other onto the plates;
c) compressing each film on a corresponding gravure plate under a vacuum;
d) exposing the films and the plates to a light source for burning the image from the films onto the gravure plates;
e) developing the image burned on the gravure plates; and
f) drying the gravure plates.

34. The method of claim 33, wherein the gravure plate is provided with a photosensitive emulsion side which is not sticky.

35. The method of claim 34, further comprising the steps of:
a) applying onto the photosensitive surface of the gravure plates a suitable powder reducing stickiness of said gravure plates prior to positioning thereon the printing films; and
b) removing said powder during development of the gravure plates.

36. The method of claim 35, wherein said powder is a talcum powder.

37. The method of claim 23, further comprising at least one of the steps selected from steps consisting of:
subjecting said substrate to a pre-treatment for increasing adhesion of the ink images to be transferred; and
subjecting the printed multicolor image to a post-treatment for increasing adhesion and long-lasting quality of said image.
